(19) United States
(12) Patent Application Publication
(10) Pub. No.: US 2007/0278365 A1
(43) Pub. Date: Dec. 6, 2007

(54) Memorabilia hanger

(76) Inventor: Russell C. Jackson, King George, VA (US)

Correspondence Address: Raymond Sun, 12420 Woodhall Way, Tustin, CA, 92782, US

(21) Appl. No.: 11/805,912

(22) Filed: May 25, 2007

Related U.S. Application Data
(60) Provisional application No. 60/803,579, filed on May 31, 2006.

(51) Int. Cl. F16M 11/00

(52) U.S. Cl. 248/176.1

(57) ABSTRACT

A memorabilia hanger includes a center pole, a topper, a base coupled to the bottom of the center pole, a pair of hanger arms extending from the center pole, and a pant hanger.

This application claims priority from Provisional Application No. 60-803,579, filed May 31, 2006, the entire disclosure of which is incorporated by this reference as though set forth fully herein.

### BACKGROUND OF THE INVENTION

1. Related Cases

2. Field of the Invention

The present invention relates to a memorabilia hanger.

### SUMMARY OF THE DISCLOSURE

In order to accomplish the objects of the present invention, the memorabilia hanger according to the present invention comprises a center pole, a topper, a base coupled to the bottom of the center pole, a pair of hanger arms extending from the center pole, and a pant hanger.

The Memorabilia Hanger is a piece of furniture that allows owners of clothing memorabilia to display them in their favorite room(s) as part of the décor, regardless of the season. Currently your favorite sports jersey or team jacket is hung on a hanger in a closet until the season starts and you take it out and wear it or show it to friends. Your grandfather's police, fire or military uniform or your grandmother's wedding dress is packed away in a closet or attic and almost never viewed, but the Memorabilia Hanger allows owners of cherished clothing memorabilia to proudly display their memorabilia to their family and friends.

### BRIEF DESCRIPTION OF THE DRAWINGS

FIG. 1 is a side elevation view of the invention 10.

FIG. 2 is a partial exploded perspective view of the invention 10.

FIG. 3 is a partial side elevation view of the pants hanger 18.

FIG. 4 is a top plan view of an alternate base 22 with storage drawers 22a and 22b.

FIG. 5 is a front elevation view of the alternate base 22 with storage drawers 22a and 22b.

FIG. 6 is a side elevation view of the alternate base 22 with storage drawers 22a and 22b.

FIG. 7 is an exploded perspective view of the alternate base 22 with storage drawers 22a and 22b.

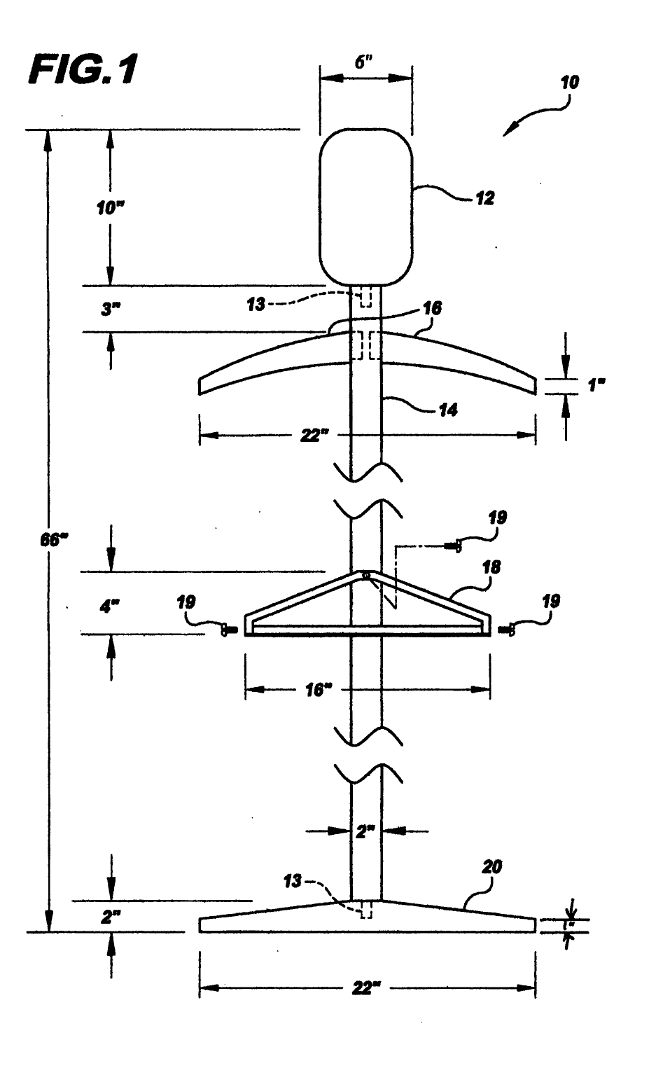

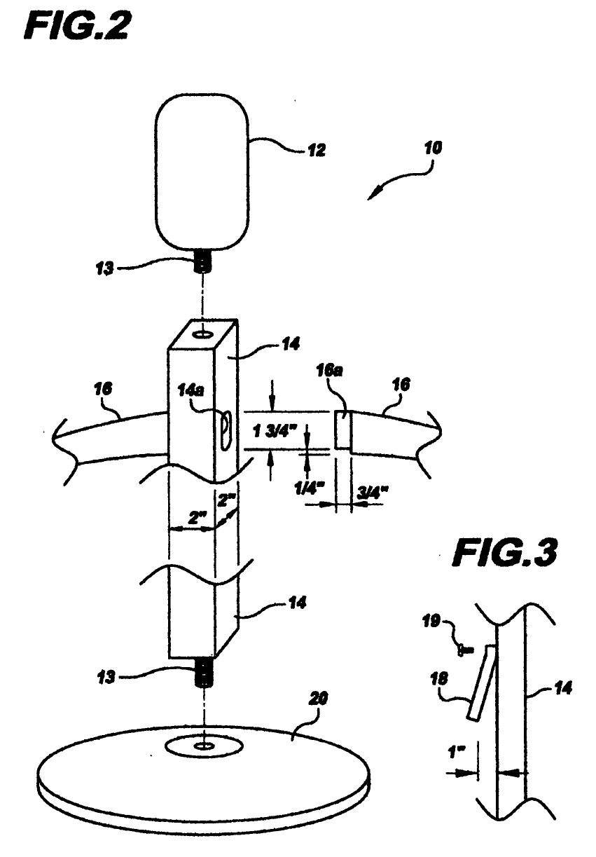

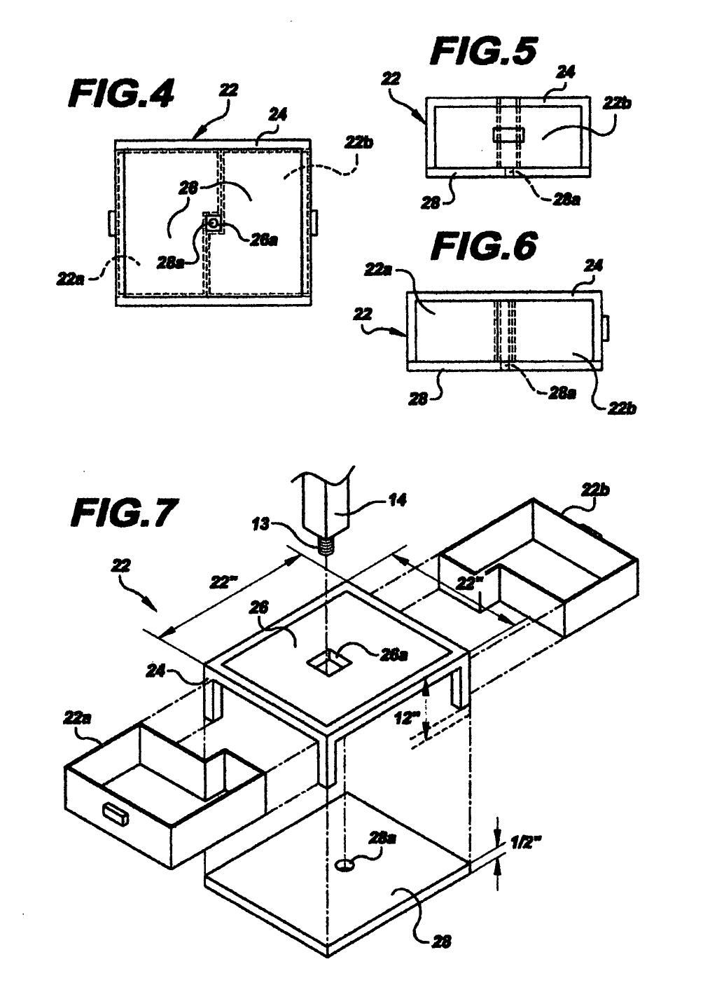

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

10 is the overall invention of a memorabilia hanger which is a piece of furniture that allows the owner of clothing memorabilia with or without head gear to display them in their favorite room or rooms regardless of the season as part of the décor. This memorabilia hanger can hold any sports jersey, jacket, antique or personal military clothing, grandmother's wedding dress, etc. The memorabilia hanger 10 can be made with or without a topper 12 and with or without pants hanger 18. The memorabilia hanger 10 can be constructed with or without a pedestal base 20. An alternate base 22 with storage drawers 22a and 22b can also be provided as an option. The alternate base can be a round or square shape. The hanger 10 can be used to hang or dry clothes, and dressed a certain way it could be used as a companion or outdoors as a guard along with using it for throwing or shooting practice.
12: is the topper.
12a: is the main frame
13: is a ½″ threaded rod to attach the topper 12 to the center pole 14 and center pole 14 to base 20.
14: is the center pole.
14a: are the recessed openings in center pole 14 that are 1 inch wide.
16: are the hanger arms that are 1 inch wide.
16a: are the inserts of hanger arms 16 that are 1 inch wide or slightly as so they can be inserted into 14a snugly.
18: is the pants hanger that is ¼ inch think
19: are the ½″ screws that attach pants hanger 18 to center pole 14 and the bottom rail of pants hanger to the upper portion.
20: is the base.
22: is an alternate base with storage drawers 22a and 22h.
22a: is an alternate base with storage drawers 22a and 22b.
22b: is the opposing side storage drawer of the alternate base.
24: is the frame of the alternate base.
26: is the top of the alternate base.
26a: is the square opening in the storage base top 24 that receives the center pole 14.
28: is the bottom of alternate storage base
28a: is the ½″ threaded opening in the bottom 28 which accepts the threaded rod 13 in the bottom of center pole 14.

The present invention is comprised of the following components:

CENTER POLE—2″ square and approx 66″ in length. It is the main shaft from which all add ons are attached.

TOPPER—An oval shaped orb in roughly the shape of a head. It is meant to have any head gear placed on it that goes with the displayed items. It can be removed if no head gear is displayed.

BASE—The standard base is round, approx 2″ thick and 22″ from one side to the other. It provides stability for the center pole.

HANGER ARMS—2 slightly angled hanger arms, one on each side of the center pole approx 9/10 of the way up. Each hanger arm is approximately 10″ long and does not exceed the footprint of the base.

PANT HANGER—Used when pants are part of the display. Pants are hung over it the same way suit pants are hung from a hanger. It is placed approximately halfway down the center pole.

OPTIONAL PEDESTAL BASE—Approx 12″ high×22″ wide×22″ long with drawers for storing additional items.

The center pole is the main shaft from which all add ons are attached to and it attaches to the base. The base provides stability for the center pole. The topper is an oval shaped orb in roughly the shape of a head. It is meant to have any head gear placed on it. The hanger arms are two slightly angled hanger arms, one on each side of the center pole approx 9/10 of the way up. Each hanger arm is approx 10″ long and does not exceed the footprint of the base. The pant hanger is used when pants are part of the display. The aforementioned components together as described here make up The Memorabilia Hanger. It is a piece of furniture that allows owners of clothing memorabilia to proudly display their cherished articles in their favorite room(s) regardless of season. Cherished family clothing heirlooms can be brought out of the closets and attics and displayed on The Memorabilia Hanger as part of your favorite room's decor for all to admire.

The Memorabilia Hanger could be used to dry or help clean clothes. It can be used to hang clothes on so they retain their shape or reduce wrinkling. It can also be used to display clothing for sale. It can be used for throwing or shooting practice. Dressed a certain way it could be used as a companion or outdoors as a guard.

The Memorabilia Hanger can be structured with or without a topper, and also with or without a pant hanger. It can be constructed with a pedestal base with drawer(s) in it for storage. The base can be flat or the base can have legs for support. It can be placed on wheels. It could be made larger or shorter. It could be made to hang from a wall or ceiling. It can be made in any number of smaller pieces so that it's easy to transport and be put back together. It can be made in any desired shape, such as square, round or any desired shape.

Thus, the present invention is a Memorabilia Hanger that allows owners of clothing memorabilia, with or without head hear, to display them in their favorite room(s) as part of the décor. Instead of having hanger hooks at the top, the Memorabilia Hanger has slightly angled hanger arms on both sides of the center pole. On the top is an almost oval shaped orb (topper). Approximately half way down there is an optional pant hanger. To display your grandfather's police uniform, the uniform hat is placed on the topper, the uniform pant is neatly hung on the pant hanger and the uniform jacket is hung from the hanger arms and buttoned up. To display a wedding dress, you would remove the optional pant hanger, hang the dress from the hanger arms and place the head piece with the vail on the topper. To display your favorite football jersey or jacket and helmet, you would remove the optional pant hanger, hang the jersey or jacket from the hanger arms and place the helmet on the topper.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A hanger assembly, comprising:
a center pole;
a topper;
a base coupled to the bottom of the center pole;
a pair of hanger arms extending from the center pole; and
a pant hanger.
